(19) United States
(12) Patent Application Publication
(10) Pub. No.: US 2025/0026027 A1
(43) Pub. Date: Jan. 23, 2025

(54) END EFFECTOR CONNECTOR FOR A ROBOTIC MANIPULATOR

(71) Applicant: Ocado Innovation Limited, Hatfield (GB)

(72) Inventor: Anthony CONTE, Toronto (CA)

(21) Appl. No.: 18/356,930

(22) Filed: Jul. 21, 2023

(51) Int. Cl. B25J 15/06; B65G 1/04; B65G 1/137

(52) U.S. Cl. CPC B25J 15/0616; B65G 1/0478; B65G 1/1373

(57) ABSTRACT

An end effector connector arranged to connect a robotic arm and an end effector comprising a suction device to releasably engage an item, in use, with vacuum pressure generated by a vacuum source. The end effector connector comprises an integrated filter assembly for the vacuum source.

### BACKGROUND

### Technical Field

The present disclosure relates generally to the field of picking stations for use in warehouses or fulfilment centers. Aspects relate to an end effector for use on a robotic manipulator assigned to such a picking station, the robotic manipulator and picking station, and a grid-based storage and retrieval system comprising the picking station.

### Description of the Related Art

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

PCT Publication No. WO2015/185628A (Ocado) describes a known storage and fulfilment system in which stacks of bins or containers are arranged within a framework structure. The bins or containers are accessed by load-handling devices operating on tracks located on the top of the frame structure. The load-handling devices are configured to lift bins or containers out from the stacks, and multiple load-handling devices can co-operate to access bins or containers located in the lowest positions of the stack. A system of this type is illustrated schematically in FIGS. 1 to 5 of the accompanying drawings.

FIG. 1 illustrates a framework structure 1 of a grid-based storage and retrieval system. The structure 1 comprises a number of upright members 3 supporting two sets of transversely arranged horizontal members 5, 7. The upright members 3 extend parallel to one another in the illustrated z-axis and stand orthogonally with respect to the horizontal members 5, 7. The first set of horizontal members 7 extend in the direction of the illustrated x-axis, while the second set of horizontal members 5 extend in the direction of the illustrated y-axis. The two sets of horizontal members 5, 7 form a grid pattern defining a plurality of grid cells. In the illustrated example, storage containers 9 are arranged in stacks 11, with each stack 11 being located beneath a respective grid cell.

FIG. 2 shows a large-scale plan view of a section of transverse track structure 13 forming part of the storage structure 1 illustrated in FIG. 1. The track structure 13 is located on top of the sets of horizontal members 5, 7. The track structure 13 may be provided by the horizontal members 5, 7 themselves (e.g., formed in or on the surfaces of the horizontal members 5, 7) or by one or more additional components mounted on top of the horizontal members 5, 7. The illustrated track structure 13 comprises x-direction tracks 17 and y-direction tracks 19, i.e., a first set of tracks 17 which extend in the direction of the illustrated x-axis and a second set of tracks 19 which extend in the direction of the illustrated y-axis. The tracks 17, 19 define apertures 15 at the centers of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure 13 are also envisaged.

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19, separated by channels 21, 23, allow bots 31 to occupy or pass one another on neighboring grid cells without colliding.

As illustrated in FIG. 4, a bot 31 comprises a body 33 on which are mounted one or more components which enable the bot 31 to perform its intended functions. These functions may include moving across the storage structure 1 on the track structure 13 and raising or lowering storage containers 9 (e.g., from or to stacks 11) so that the bot 31 can retrieve or deposit storage containers 9 in specific locations defined by the grid pattern. The bot 31 further comprises first and second sets of wheels 35, 37 which are mounted on the body 33 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19. The bot 31 also comprises container-lifting means, generally designated by 39, configured to raise and lower containers 9. The container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with corresponding features of the containers 9. For instance, the containers 9 may be provided with one or more apertures in their upper sides with which the engaging means can engage. Alternatively or additionally, the container engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the bot 31 has an upper portion 45 and a lower portion 47. The upper portion 45 is configured to house the one or more operation components (not shown) that enable the bot 31 to perform its intended functions, and the lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space may not be within the body 33 of the bot 31. For example, in some embodiments, the container-receiving space may be adjacent to the body 33 of the bot 31, e.g., in a cantilever arrangement with the weight of the body 33 of the bot 31 counterbalancing the weight of the container to be lifted. In such embodiments, a frame or arms of the container-lifting means 39 may protrude horizontally from the body 33, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the center of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 to bring the at least one set of wheels 35, 37 out of and into contact with the tracks 17, 19. In some examples, only one set of wheels 35, 37 is configured to be raised and lowered, and the act of lowering the one set of wheels 35, 37 may effectively lift the other set of wheels 35, 37 clear of the corresponding tracks 17, 19, while the act of raising the one set of wheels 35, 37 may effectively lower the other set of wheels 35, 37 into contact with the corresponding tracks 17, 19. In other examples, both sets of wheels 35, 37 may be capable of being raised and lowered, advantageously meaning that the body 33 of the bot 31 stays substantially at the same height and therefore the weight of the body 33 and the components mounted thereon does not need to be lifted and lowered by the wheel-positioning mechanism.

As shown in FIG. 3, a plurality of identical load-handling devices 31 are provided, so that each load-handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers 9 transported to a port by a load-handling device 31 can be transferred to another location by the conveyor system, for example to a picking station (not shown). Similarly, containers 9 can be moved by the conveyor system to a port from an external location, for example to a container-filling station (not shown), and transported to a stack 12 by the load-handling devices 30 to replenish the stock in the system.

Each load-handling device 31 can lift and move one container 9 at a time. If it is necessary to retrieve a container 9 (“target container 9”) that is not located on the top of a stack, then the overlying containers 9 (“non-target containers 9”) must first be moved to allow access to the target container. This is achieved in an operation referred to hereafter as “digging.” During a digging operation, one of the load-handling devices 31 sequentially lifts each non-target container from the stack 11 containing the target container and places it in a vacant position within another stack 11. The target container can then be accessed by the load-handling device 31 and moved to a port for further transportation.

Each of the load-handling devices 31 is under the control of a central computer. Each individual container 9 in the system is tracked so that it can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a wide range of different items in the containers, while allowing reasonably economical access to all of the containers when required for picking.

With reference to FIG. 6, the system may further comprise a robotic picking station, generally designated by 50, mounted on top of the structure 1, alongside the load-handling devices 31 (not shown). The robotic picking station 50 comprises a robotic manipulator 52 comprising a robotic arm 54 and an end effector 56 for releasably engaging a product to be manipulated, together with several designated grid cells 60, 62. The robotic manipulator 52 is mounted on a plinth 58 above a single grid cell 60 and, depending on its location on the structure 1, can be surrounded by up to eight other grid cells 62. In general, the robotic manipulator 52 is configured to pick an item or product from any one of the containers 9 located in one of the designated grid cells 62 and place it in a container 9 located in another one of the cells 62. The load-handling devices 31 collect containers 9 from, and deliver them to, the designated grid cells 62 as necessary. In this way, the robotic picking station 50 and the load-handling devices 31 work in conjunction to fulfil a customer order or redistribute products throughout the structure 1. The end effector 56 comprises a suction device 64 connected to a vacuum source in the form of a rotary vane pump (not shown). The vane pump forms part of a low pressure circuit configured to provide a vacuum pressure at the suction device 64, enabling it to attach to a product to be manipulated. The vane pump is positioned away from the top of the storage and retrieval structure 1 due to its size and weight, and so as not to occupy any grid cells. Instead, it is typically positioned at ground level, where it can be easily accessed, making its installation and maintenance more straightforward. However, this arrangement poses a number of problems. First, positioning the vane pump at ground level can present a burn hazard because of the heat it generates during use. Second, because of the distance between the vane pump and suction device 64, which can be in the order of several meters, a large diameter vacuum line 66 must be used in order to minimize the vacuum loss between the vane pump and suction device 64. However, in order to prevent its collapse due to the vacuum pressure, the vacuum line 66 must be reinforced, making it reasonably stiff. This can reduce the dexterity of the robotic manipulator 52 since it is necessary to mount the vacuum line 66 on the robotic arm 54 in order to route it to the suction device 64. Lastly, the use of vane pumps is not appropriate for some environments (e.g., chilled areas) since they are typically not rated to work below 5° C.

### BRIEF SUMMARY

Accordingly, provided herein is an end effector connector arranged to connect:
a robotic arm; and
an end effector comprising a suction device to releasably engage an item, in use, with vacuum pressure generated by a vacuum source;
the end effector connector comprising an integrated filter assembly for the vacuum source.

This arrangement allows for the entire end effector assembly, including the vacuum filter of the connector and the end effector when connected via the connector, to be disconnected and reconnected from the robotic arm. Thus, downtime associated with a faulty filter, e.g., a filter element that needs replacing, can be reduced by disconnecting the end effector assembly and replacing it with a functional one while the filter of the removed one is fixed. For example, in other systems, removing the vacuum filter, or faulty parts thereof, from the robotic arm could take longer and require specialist tools, particularly where there are multiple mounting points on or near the robotic arm.

### BRIEF DESCRIPTION OF THE SEVERAL VIEWS OF THE DRAWINGS

These and other aspects will now be described, by way of example only, with reference to the accompanying drawing, in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station;

FIG. 7 shows a schematic depiction of a robotic picking station in accordance with an embodiment;

FIG. 8 is an exploded view of an end effector assembly, including an end effector connector, for use in the robotic picking station of FIG. 7;

FIGS. 9A and 9B show two isometric views of the end effector assembly of FIG. 8;

FIGS. 10A and 10B show cross-sectional views of a manifold used in a suction assembly of the end effector connector of FIG. 8 in vertical and horizontal planes along line A-A in FIG. 9A;

FIG. 11 shows a schematic depiction of a fluid power circuit used with the end effector connector of FIG. 8 in one operating mode;

FIG. 12 shows a schematic depiction of the fluid power circuit of FIG. 11 in a different operating mode;

FIG. 13 shows an isometric view of a structural frame of the end effector connector of FIG. 8;

FIGS. 14A and 14B show isometric and cross-sectional views of the ends of a twist-lock connection system respectively; and,

FIGS. 15A and 15B show plan views of the twist-lock connection system in an unlocked and locked state, respectively.

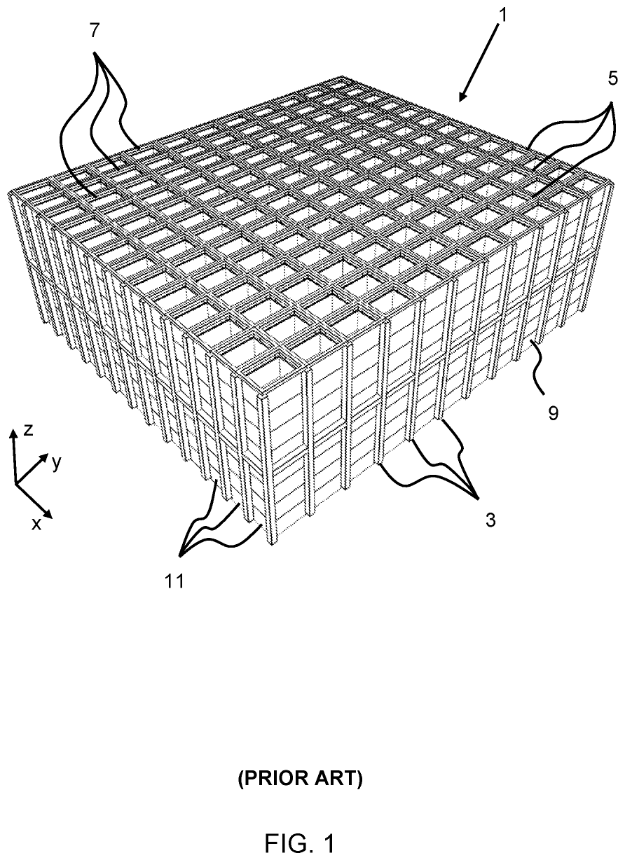

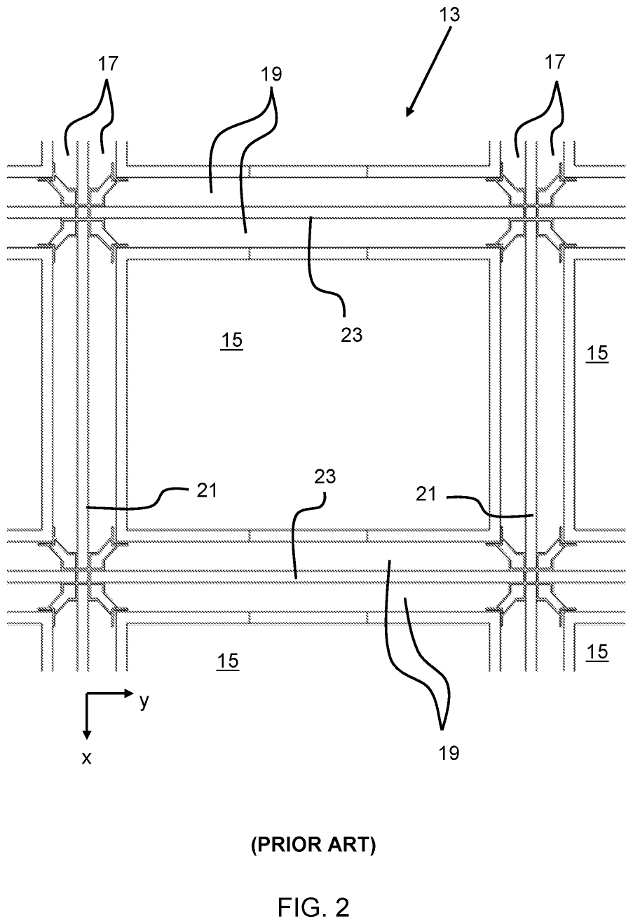

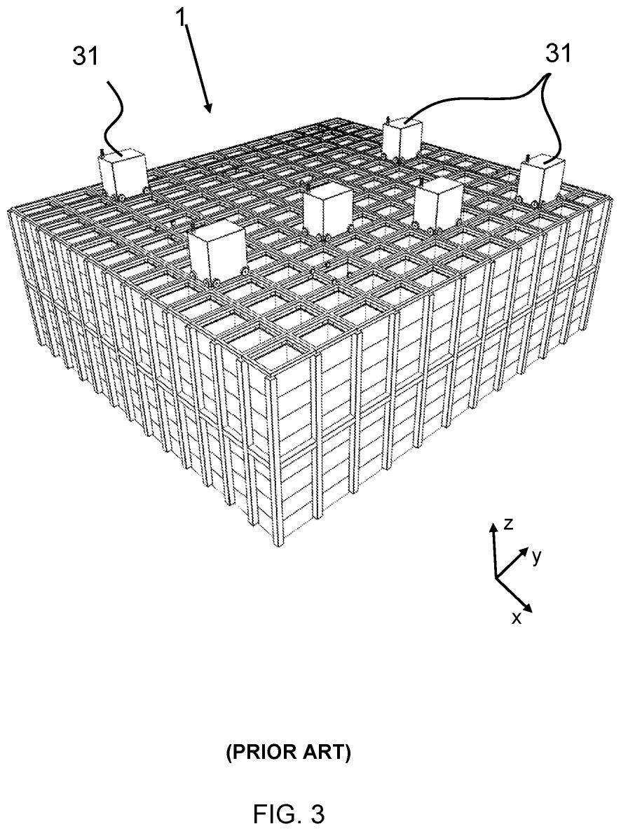

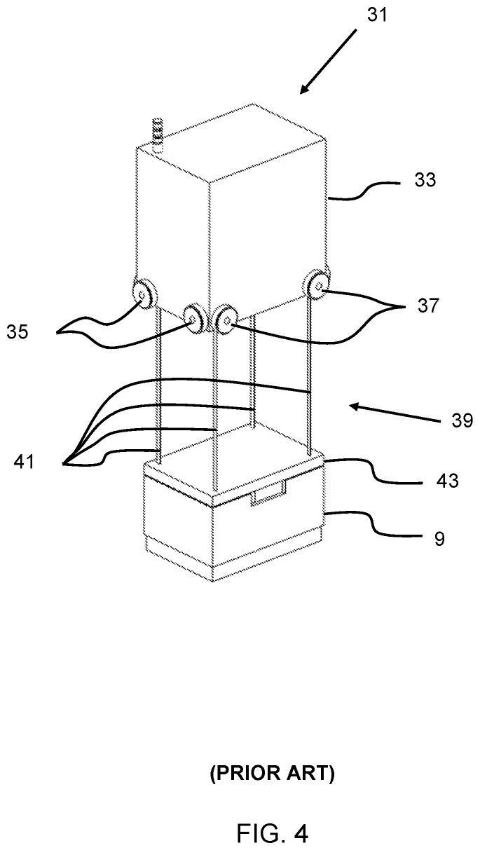

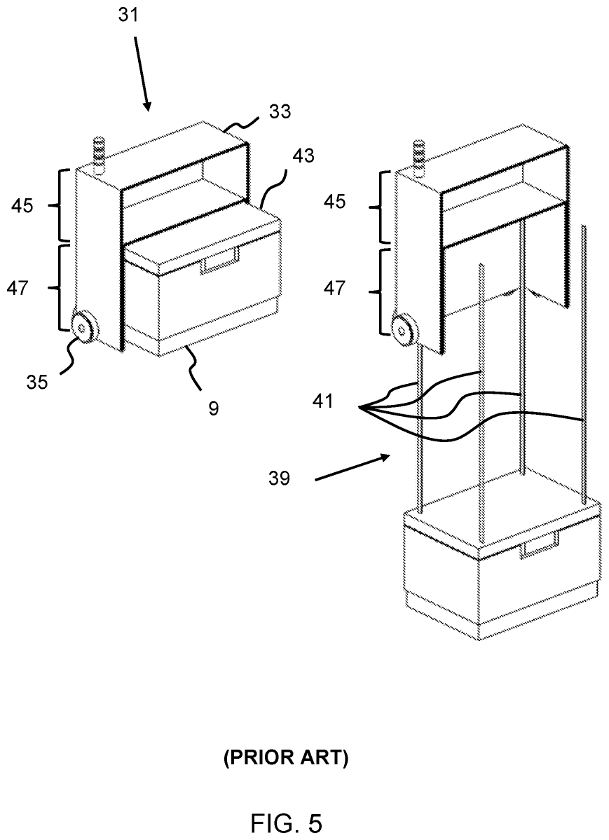

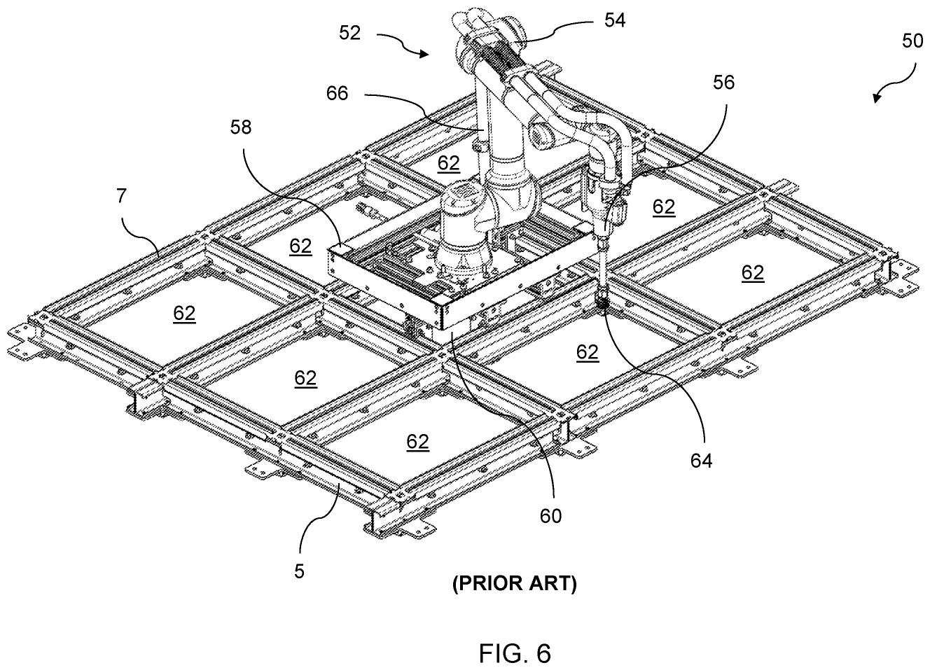

In the drawings, like features are denoted by like reference signs where appropriate.

### DETAILED DESCRIPTION

In the following description, some specific details are included to provide a thorough understanding of the disclosed examples. One skilled in the relevant art, however, will recognize that other examples may be practiced without one or more of these specific details, or with other components, materials, etc., and structural changes may be made without departing from the scope defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one,” “an,” or “another” applied to “embodiment,” “example,” means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the use of the articles “a,” “an,” and “the” include plural referents unless the content clearly dictates otherwise. It should also be noted that the term “or” is generally employed in its sense including “and/or” unless the content clearly dictates otherwise.

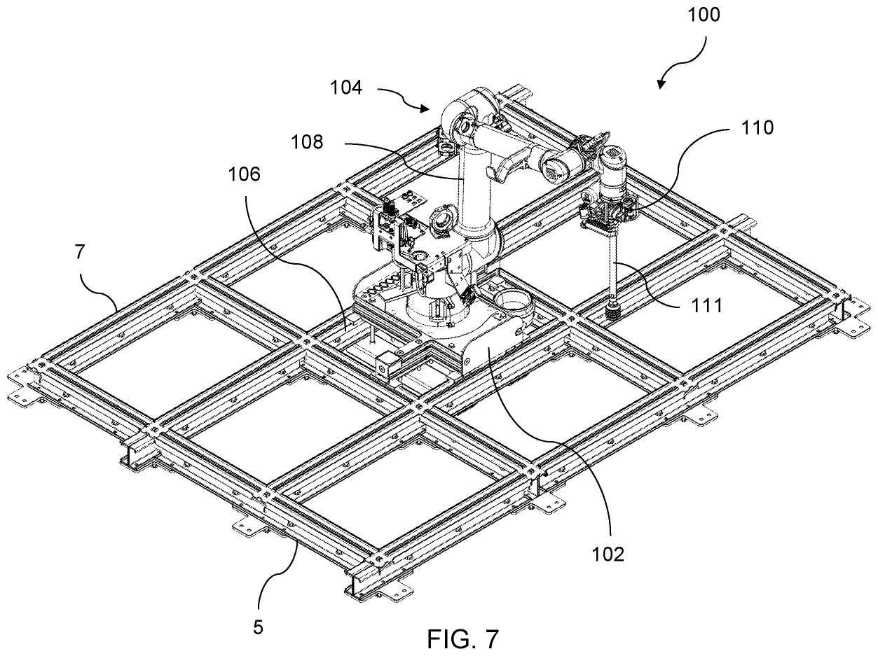

FIG. 7 shows a schematic depiction of a robotic picking station 100 according to an embodiment. The robotic picking station 100 is mounted on a framework structure 1 similar to that previously described, and forms part of a grid-based storage and retrieval system. The robotic picking station 100 comprises a plinth 102 upon which a robotic manipulator 104 is mounted. The plinth 102 is of a size and shape such that it may be largely received within a space located above a single grid cell 106 whilst providing sufficient clearance to permit load-handling devices to traverse adjacent grid cells. The plinth 102 may be secured to one or more upright members of the framework structure 1. Alternatively or additionally, the plinth 102 may be fastened to one or more of the horizontal members 5, 7 of the structure 1. A surface of plinth 102 may extend across substantially the entirety of the grid cell 106 above which it is located, reducing the risk that a dropped item or product falls into the structure 1 and consequently interferes with the operation of the system. Alternatively, the surface of the plinth 102 may only partially extend across its corresponding grid cell 106.

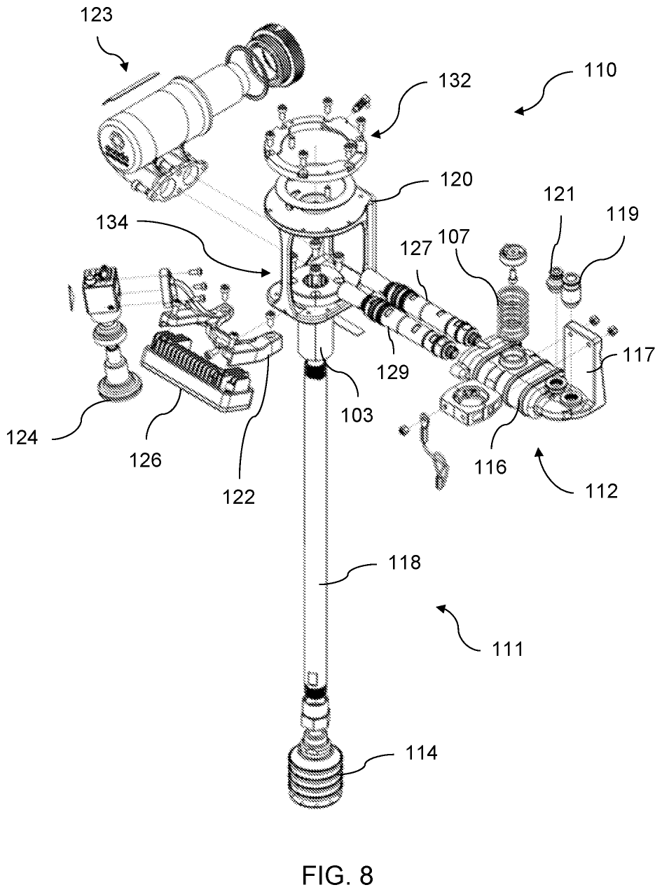

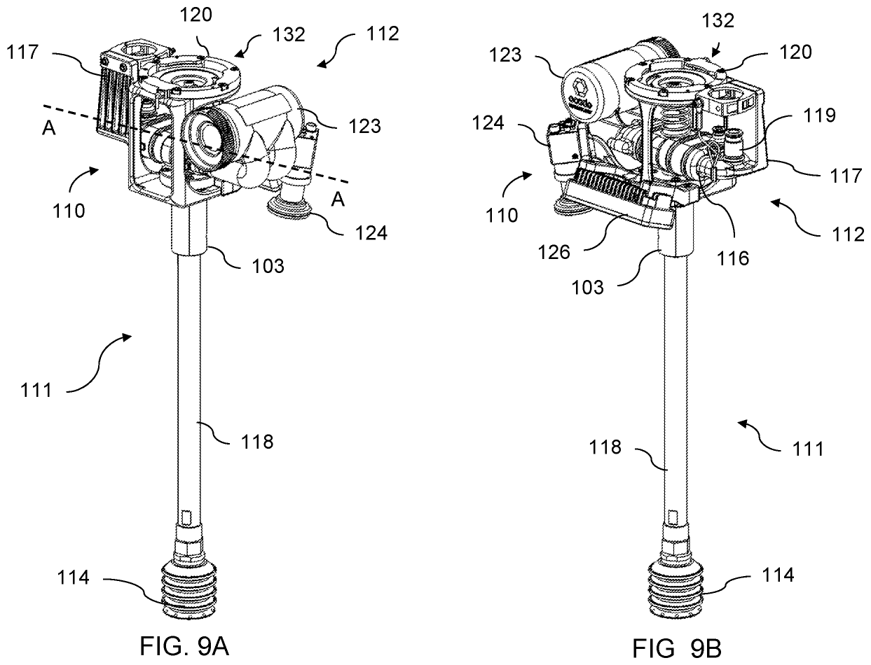

With further reference to FIGS. 8, 9A and 9B, the robotic manipulator 104 comprises a robotic arm 108 and an end effector 111 connected to the robotic arm 108 by an intermediate end effector connector 110. The end effector connector 110 and end effector 111 together form an end effector assembly.

In one aspect, the end effector connector 110 comprises a suction assembly, generally designated by 112, having an integrated vacuum source. With the end effector 111, comprising a suction device 114, connected to the end effector connector 110, the integrated vacuum source is configured to produce a vacuum or suction pressure that is usable to releasably engage an object or item with the suction device 114. For example, the vacuum pressure generated by the integrated vacuum source of the end effector connector 110 can act at the suction device 114, when connected via the connector 110, to engage the item. In examples, the suction assembly 112 of the end effector connector 110 includes a connection element, such as a threaded element, configured to engage with a corresponding connection element on the end effector 111 so as to fluidically connect the suction assembly 112 and suction device 114.

In some examples, as described below with reference to the embodiment shown in FIGS. 8, 9A, 9B, 10A and 10B, the integrated vacuum source comprises one or more venturi vacuum generators connectable to a pressure source (not shown) for providing a pressurized air supply thereto. A vacuum manifold may fluidically connect the one or more venturi vacuum generators, e.g., to the suction device 114 when connected to the connector 110.

The end effector connector 110 having an integrated vacuum source reduces vacuum losses between the vacuum source and suction device, e.g., by reducing the effective length of the vacuum line therebetween, compared to other solutions. For example, in systems where the vacuum source is located away from the robotic arm or is mounted on a linkage of the robotic arm, the distance between the vacuum source and the suction device is longer, meaning more power is needed to generate an equivalent vacuum pressure (or suction force) at the suction device due to the larger pressure drop. Furthermore, the integrated vacuum source of the end effector connector 110 allows for the entire end effector assembly to be removed and replaced if there is dysfunction of the vacuum system. Thus, the need to isolate where along the vacuum line the issue (e.g., blockage) is located, in order to disconnect and replace the relevant parts mounted on or off the robotic arm, is removed thereby saving time. In the present system, the robotic arm can function with the replacement end effector assembly while the dysfunctional end effector assembly is examined and repaired, thus reducing unplanned downtime and associated production loss compared to repairing a mounted vacuum source and/or vacuum line in situ on the robotic arm.

In another aspect, the end effector connector 110 comprises an integrated filter assembly 123 for the vacuum source. The vacuum source may be external to the end effector connector 110 in this aspect, for example fluidically connected to the end effector connector 110 comprising the integrated filter assembly 123. In other examples, the vacuum source is integrated into the end effector connector 110 too, as in the aforementioned aspect.

In some examples, the integrated filter assembly 123 is arranged to filter an outlet or exhaust of the vacuum source, e.g., as an exhaust filter assembly. The integrated exhaust filter assembly 123 allows for filtering of material, e.g., dust or particulate matter, which could otherwise be dispersed by the vacuum system as the robotic arm 108 moves around the picking station.

Additionally, or alternatively, the end effector connector 110 includes a filter assembly arranged to filter an inlet of the vacuum source. The integrated inlet filter assembly allows for filtering of material sucked into the vacuum line which could damage the vacuum system. Placing the inline filter closer to the suction device reduces the length of vacuum line which is susceptible to clogging up from loose material in the environment sucked in by the suction device 114. For example, in the context of a robotic picking station 100 for picking grocery items, the integrated inline filter can protect the upstream vacuum system from leaked liquids, semi-solids, colloids, gels, etc. that may be sucked into the vacuum line by the suction device 114 during a picking operation. Integrating the inline filter into the end effector connector 110 such that it is located between the suction device 114 and vacuum source in use can thus protect the vacuum source. Locating the inline filter at the inlet of the end effector connector 110, e.g., where it connects to the suction end effector 111 in use, also narrows down where an incident blockage in the vacuum line can be, i.e., to within the suction end effector 111 itself rather than upstream conduits, tubing, etc., which can speed up resolution of the blockage.

In examples, the end effector connector 110 includes both filter assemblies, i.e., a first integrated filter assembly arranged to filter the exhaust of the vacuum source, and a second integrated filter assembly arranged to filter the inlet of the vacuum source. Integrating either or both of the filter assemblies into the end effector connector 110 removes the need to separately mount the filter assembly elsewhere in the vacuum system, e.g., on the robotic arm 108. Thus, a simpler construction of the robotic picking station 100 can be achieved without extra tubing, attachments, etc. mounted onto the robotic arm 108.

The specific example of the end effector connector 110 shown in FIGS. 8, 9A and 9B comprises an integrated suction assembly 112 and a camera mount 122, both of which are mounted to a structural frame 120 that also forms part of the end effector connector 110. The camera mount 122 supports a couple of imagers or cameras 124, 126 for acquiring environmental visual information used in the control of the robotic manipulator 104. The suction assembly 112 is movably mounted on the structural frame 120 and is configured to produce a vacuum or suction pressure that is used to releasably engage an object or item during its manipulation. A fluid power circuit (not shown) supplies pressurized air directly to the suction assembly 112 for the generation of the vacuum pressure.

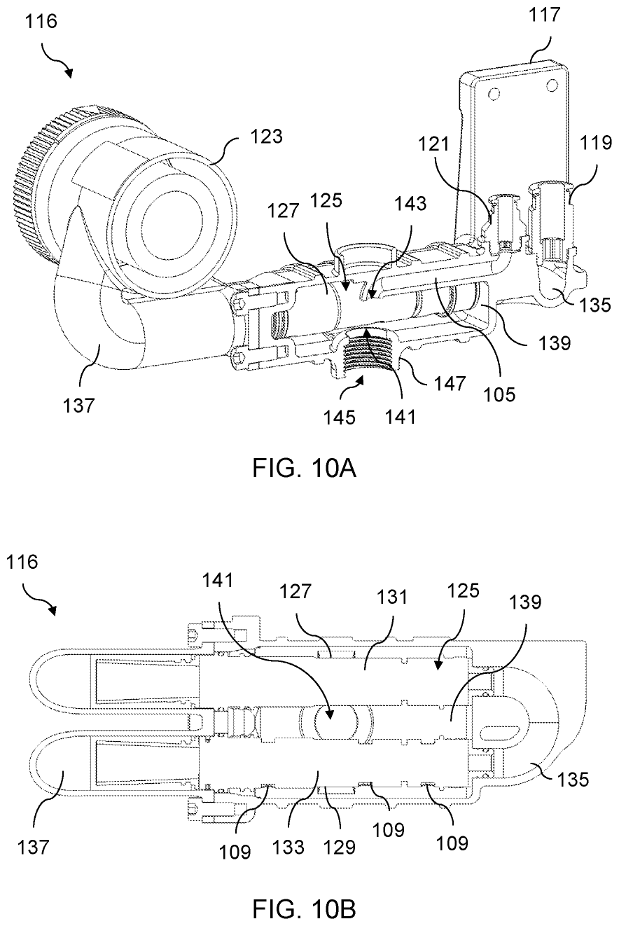

With the end effector 111 connected to the connector 110, the suction assembly 112 comprises a suction cup 114, a manifold 116 and an elongate stem 118 connecting the suction cup 114 and manifold 116. The stem 118 and suction cup 114 form the end effector 111 in this example. The manifold 116 comprises a conduit bracket 117 for guiding tubing of the fluid power circuit to a pair of connectors 119, 121, along with an integrated filter assembly 123. A hole 134 in the structural frame 120 provides passage for the stem 118 from its connection with the manifold 116 to the suction cup 114. A linear bearing assembly 103 comprising a bearing surface extending through the hole 134 is provided to facilitate axial movement of the stem 118, together with the other components of the suction assembly 112, relative to the structural frame 120, thus providing a degree of compliance to the suction assembly 112 whilst picking or packing items. A coil spring 107 is disposed between the manifold 116 and a top assembly 132 of the structural frame 120 to provide a biasing force to return the suction assembly 112 to its lowermost position following any upward displacement. A protrusion 147 (shown in FIG. 10A) extending downwards from the outer wall of the manifold 116 is configured to abut an upper surface of the bearing assembly 103, limiting the downward movement of the suction assembly 112 with respect to the frame 120 to define its lowermost position.

With reference to FIGS. 10A and 10B, the manifold 116 further comprises a chamber 139 and at least one vacuum generator 125. In this example, the vacuum generator 125 comprises two parallel venturi generators 127, 129 housed within the chamber 139. Each of the venturi generators 127, 129 includes a venturi restriction 131, 133 and an array of holes 109 in its sidewall, providing fluid communication between the restriction 131, 133 and chamber 139.

A first channel 135 formed within the manifold 116 provides a fluid connection between the first connector 119 and venturi generators 127, 129, branching in a uniform manner so as to minimize differences in pressure drop across the channel 135. The first channel 135 is configured to direct pressurized air supplied to the first connector 119 through the venturi generators 127, 129 in order to generate a vacuum pressure within the venturi restrictions 131, 133. Ducting 137 guides air exiting the venturi generators 127, 129 to the integrated filter assembly 123, positioned downstream of the vacuum generator 125, where it is then exhausted from the manifold 116.

The chamber 139 comprises two openings 141, 143 in fluid communication with the venturi restrictions 131, 133. A first opening 141 is one end of a passage 145 defined by the protrusion 147 that extends downward from the outer wall of the manifold 116. The inner surface of the protrusion 147 and the outer surface of the upper end of the elongate stem 118 are provided with corresponding screw threads that secure the stem 118 to the protrusion 147 when connecting the end effector 111 to the connector 110. In this way, the passage 145 extends between the chamber 139 and the interior of the stem 118, thus enabling propagation of vacuum pressure from the venturi restrictions 131, 133 to the suction cup 114.

The second opening 143 of the chamber 139 is connected to the second connector 121 by a second channel 105 formed within the manifold 116. This unique arrangement permits the second channel 105 to serve two functions or modes of operation. First, it can be used to facilitate the measurement of vacuum pressure within the chamber 139. This is important in order to verify that the vacuum generator 125 is performing as expected and that the requisite vacuum pressure in the chamber 139 is being achieved. This helps, not only in situations where there is an unexpected increase in pressure within the chamber 139 that might require immediate attention, but also in calling attention to any low-level errors, such as a leak at connector 119, that, whilst not warranting prompt action, might increase over time without rectification. Second, the second channel 105 can alternatively be used to deliver pressurized air to the chamber 139 in order to provide positive pressure at the suction cup 114 to “blow-off” an item carried by the end effector 111 or attempt to dislodge a blockage within the manifold 116 or fluid power circuit.

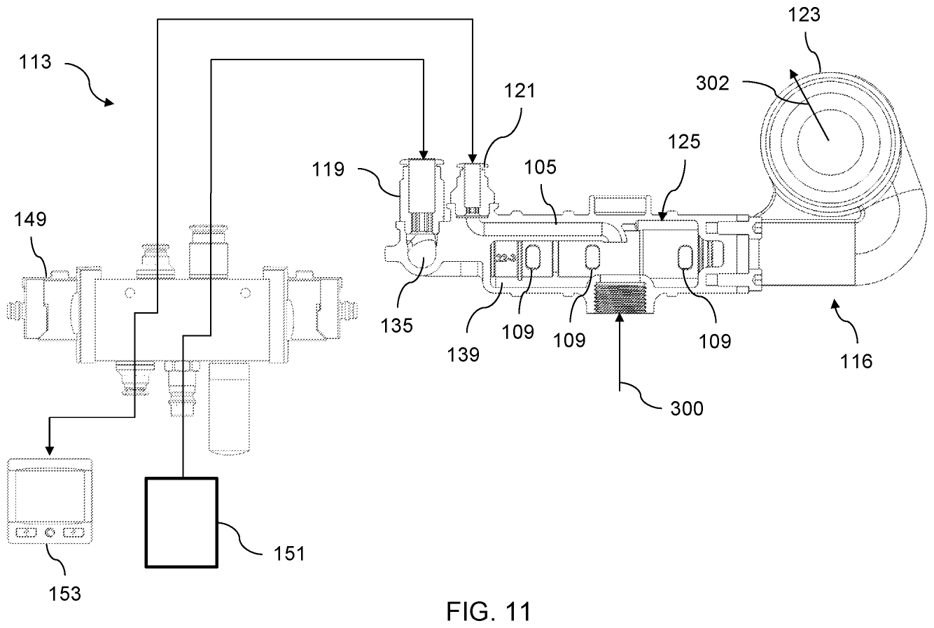

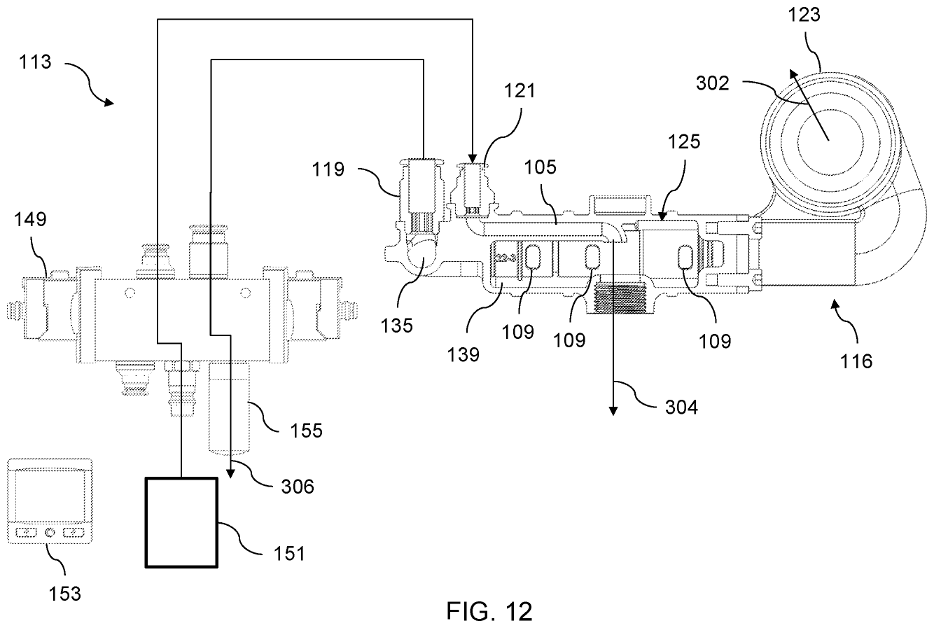

These operating modes will now be described in more detail with reference to FIGS. 11 and 12. The fluid power circuit 113 comprises a reconfigurable valve assembly 149 that fluidly connects, through appropriate tubing and connectors, the manifold 116 to a pressure source 151 and a vacuum measurement unit 153. In a first configuration, representing the first operating mode as shown in FIG. 11, the valve assembly 149 routes pressurized air from the pressure source 151 to the first channel 135 of the manifold 116 from where it is then directed through the vacuum generator 125, creating a vacuum pressure that propagates to the suction cup 114, as indicated by arrow 300, and then exits the manifold 116 through the integrated filter assembly 123, as indicated by arrow 302. In this configuration, the valve assembly 149 is also arranged to connect fluidly the second channel 105 of the manifold 116 to the vacuum measurement unit 153, whilst simultaneously isolating the second channel 105 from the pressure source 151, in order to monitor the vacuum pressure within the chamber 139.

In a second configuration, representing the second operating mode as shown in FIG. 12, the valve assembly 149 is reconfigured to disconnect the second channel 105 and vacuum measurement unit 153, and instead established a fluid connection between the pressure source 151 and the second channel 105 so as to be able to pressurize the chamber 139 of the manifold 116. In this configuration, the valve assembly 149 isolates the first channel 135 from the pressure source 151, and instead establishes a fluid connection between the channel 135 and a filter assembly 155 carried on the valve assembly 149. This allows the relief through the first channel 135, together with the integrated filter assembly 123 and stem 118, of any overpressure within the chamber 139 during this operating mode, as indicated by arrows 302, 304, 306.

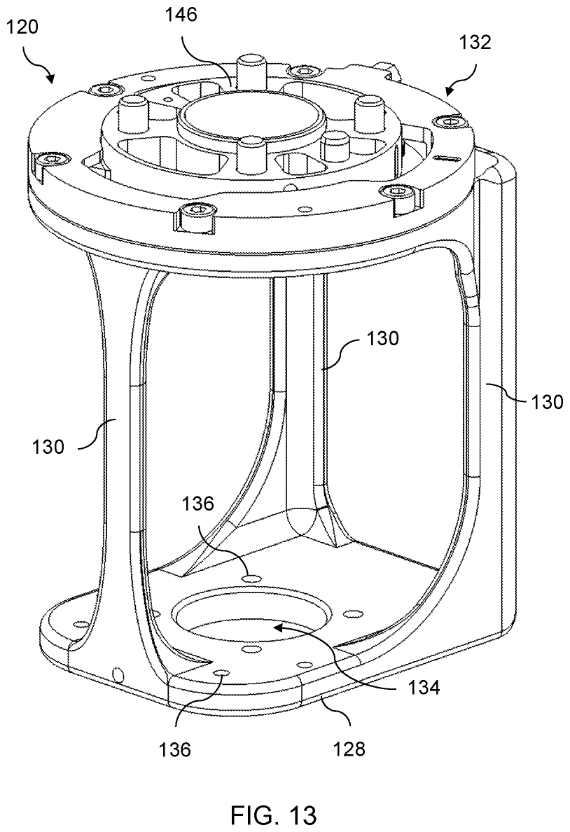

FIG. 13 shows an isometric view of the structural frame 120 connected to a male end 146 of a twist-lock connection system. The structural frame 120 comprises a base section 128 and three elongate struts 130 connecting the base segment 128 to the top assembly 132. The base section 128 comprises the hole 134 located near to its center, providing passage for the stem 118 from its connection with the manifold 116, and a plurality of fastener points 136 for the camera mount 122 and bearing assembly 103.

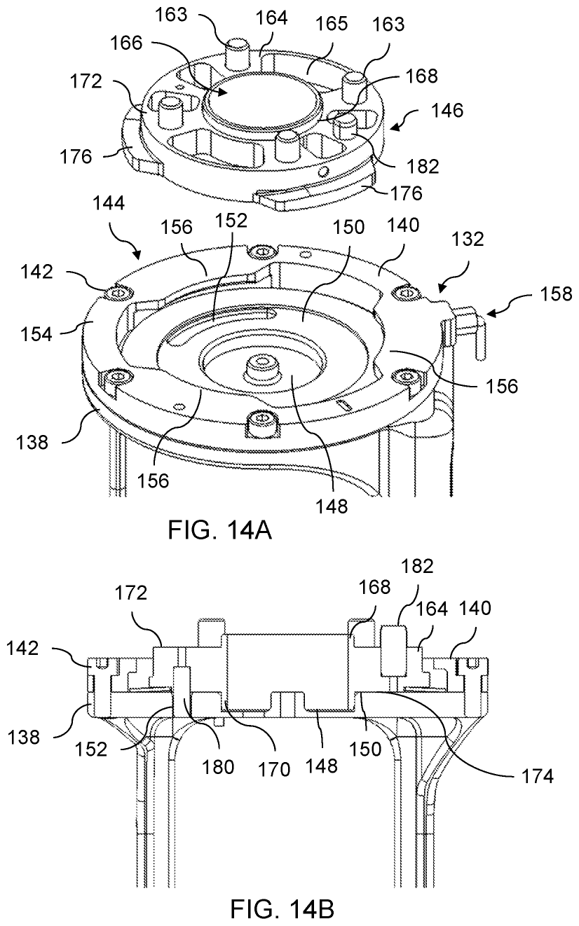

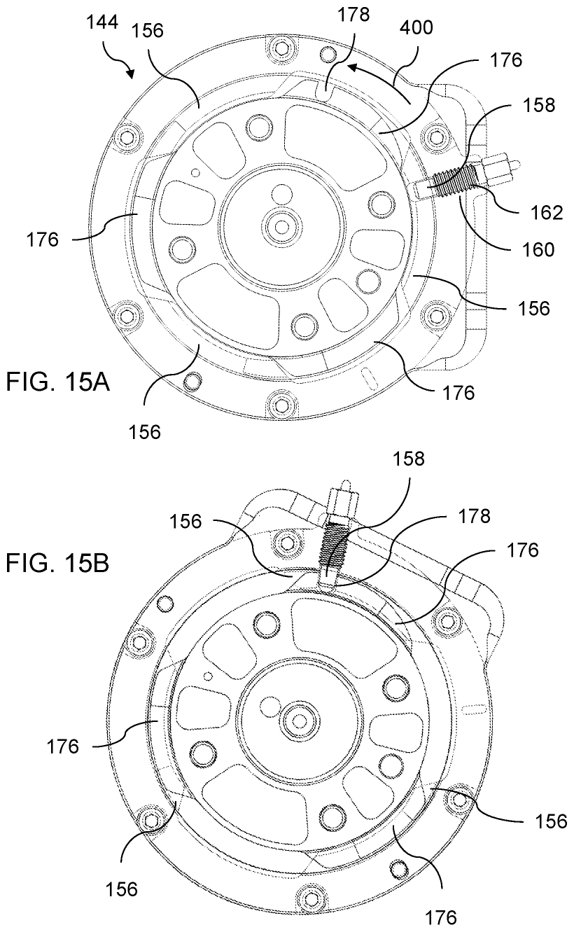

With reference to FIGS. 14A and 14B, the top assembly 132 of the structural frame 120 comprises lower and upper segments 138, 140 secured together with a plurality of fasteners 142. The base section 128, elongate struts 130 and lower segment 138 define a unibody frame. The lower and upper segments 138, 140 collectively define a female end 144 of a twist-lock connection system, with the corresponding male end 146 being secured to a flange (not shown) fastened at a terminal end portion of the robotic arm 108. The lower segment 138 comprises a central circular hollow 148 bordered by a concentric interface surface 150 into which an arcuate slot 152 is cut. The upper segment 140 defines a flange 154 comprising three overhangs 156 extending radially inwards from its upper inner edge to project over at least part of the interface surface 150, but without covering the arcuate slot 152. The upper segment 140 further comprises a radially aligned pin 158 carried within a bore 160 in the side of the flange 154, together with a coil spring 162 (as shown in FIG. 15A). The spring 162 is housed within the bore 160 and is configured to bias the radial pin 158 inwardly.

In addition to a plurality of fasteners 163 for securing it to the robotic arm 108, and multiple cutouts 165 for reducing its weight, the male end 146 comprises a generally disc-like structure 164 that includes a central open bore 166. The bore 166 is partly defined by walls 168, 170 protruding beyond upper and lower surfaces 172, 174 of the structure 164. The wall 170 extending beyond the lower surface 174 is configured to fit within the circular hollow 148 formed in the lower segment 138 to help correctly locate the male end 146 with respect to the female end 144 of the twist-lock connection system. The wall 168 protruding beyond upper surface 172 of the structure 164 serves a similar function but instead with a hollow formed within the flange fastened to the end of the robotic arm 108.

The structure 164 further comprises three protrusions 176 jutting radially outwards from its lower outer edge, each protrusion 176 being configured to meet a corresponding overhang 156 of the flange 154 to hold the female and male ends 144, 146 together. One of the protrusions 176 comprises a cutout 178 configured to receive the radial pin 158 when the female and male ends 144, 146 are correctly connected, providing a rotational lock therebetween. In order to ensure a coming together of the radial pin 158 and the appropriate protrusion 176 when connecting the end effector connector 110 to the robotic arm 108, the male end 146 further comprises an axially aligned pin 180 configured to extend into the arcuate slot 152 when the female and male ends 144, 146 are correctly connected. The respective positions of the axial pin 180 and arcuate slot 152 are arranged so that the lower surface 174 of the structure 164 sits flush with the interface surface 150 of the lower segment 138 only when the radial pin 158 is interacting with the appropriate protrusion 176. In all other instances, the axial pin 180 will sit on the interface surface 150, preventing a proper fitting between the female and male ends 144, 146. The male end 146 also comprises an axially aligned pin 182 standing proud of the upper surface 172 of the structure 164. This pin 182 is used to ensure that the male end 146 is correctly positioned with respect to the flange fastened at the end of the robotic arm 108.

With reference to FIGS. 15A and 15B, in order to secure the end effector connector 110 to the robotic arm 108, one simply has to bring the female end 144 of the twist-lock connection system into contact with the male end 146 in such a way that the pin 180 of the male end 146 is received within one end of the arcuate slot 152 of the interface surface 150. If it is correctly received, the protrusions 176 of the male end 146 are located between the overhangs 156 of the female end 144. From this position, the end effector connector 110 is rotated in an anticlockwise direction, as indicated by arrow 400, to move each one of the overhangs 156 into a position above a respective protrusion 176. During this movement, the radial pin 158 runs along the peripheral surface of its corresponding protrusion 176 under the biasing force of the spring 162 until it is received within the cutout 178, preventing any further rotation of the end effector connector 110 and locking it into position with respect to the robotic arm 108. In order to remove the end effector connector 110, one simply pulls the radial pin 158 out of the cutout 178, against the biasing force of the spring 162, and rotates the connector 110 in a clockwise direction until the protrusions 176 are clear of the overhangs 156, at which point the connector 110 can be pulled clear of the robotic arm 108.

In the example shown, the male end 146 of the twist-lock connection system is fixedly secured to the robotic arm 108, whereas the female end 144 is formed from the top assembly 132 of the structural frame 120. Other embodiments are envisaged in which it is the female end 144 of the twist-lock connection system that is secured to the robotic arm 108 and the top assembly 132 of the structural frame 120 defines the male end 146. Both variants, however, provide the benefit of a straightforward and convenient procedure for connecting and disconnecting the end effector connector 110, e.g., together with the end effector 111 as an end effector assembly, and robotic arm 108 without the use of additional or specialist tools. This arrangement provides benefits regardless of location of the robotic arm 108, but is particularly advantageous if the robotic arm 108 is located in a position that is not easily accessed, such as on the framework structure 1, where carrying out maintenance work is potentially awkward. And the fact that the suction assembly 112 is integral to the end effector connector 110 further improves the convenience of this arrangement as there is no need to rectify any faults with the suction assembly 112 in situ, but instead the faulty connector 110 can be replaced with a new one simply by disconnecting and reconnecting the tubing to the connectors 119, 121.

The present disclosure describes examples of how the disclosure may be practiced, and it will be appreciated by those skilled in the art that a variety of approaches may be adopted without departing from the scope of the disclosure as defined by the appended claims.

The above examples are to be understood as illustrative. Further examples are envisaged. For instance, the specific example of the end effector connector 110 shown in FIGS. 8, 9A and 9B includes a camera mount 122 which may not be present in other examples.

Furthermore, in the specific example of the end effector connector 110 shown in the Figures, the vacuum generator 125 comprises two parallel venturi generators 127, 129 whereas in other examples, there may be a single venturi generator, or more than two venturi generators. For example, generally, there may be one or more vacuum generators 125 integrated into the end effector connector 110.

Furthermore, the second channel 105 within the chamber 139 of the vacuum manifold 116, including the corresponding opening 143 and connector 121, may not be present in alternative examples to the one shown in the Figures. For instance, the end effector connector 110 according to some of the described aspects may be embodied without these structural features and their associated functionality, i.e., the measurement of vacuum pressure within the chamber 139 and provision of positive “blow-off” pressure. In such simplified embodiments, the vacuum manifold 116 has a single connector 119 for connecting to a pressurized air source, the pressurized air supplied thereby being directed to the vacuum generator 125 via the first channel 135.

Furthermore, examples are envisaged in which the structural arrangement of the end effector connector 110 is different to that shown in FIGS. 8 to 12. For example, there may be no protrusion 147 at the connection point for connecting the end effector 111 as shown. Similarly, the associated passage 145 extending between the vacuum manifold 116 and the end effector 111, when connected, may be arranged in the connector 110 differently to the example shown, such as displaced to one side of the manifold 116 rather than directly underneath.

It is also to be understood that any feature described in relation to any one example may be used alone, or in combination with other features described, such as in combination with one or more features of any other of the examples, or any combination of examples.

Various examples can be realized according to the following clauses:
1. An end effector connector arranged to connect:
   a robotic arm; and
   an end effector comprising a suction device to releasably engage an item, in use, with vacuum pressure generated by a vacuum source;
   the end effector connector comprising an integrated filter assembly for the vacuum source.
2. The end effector connector according to clause 1, wherein the integrated filter assembly is arranged to filter an exhaust of the vacuum source.
3. The end effector connector according to clause 1 or 2, wherein the integrated filter assembly is a first integrated filter assembly, the end effector comprising a second integrated filter assembly arranged to filter an inlet of the vacuum source.
4. The end effector connector according to clause 1, wherein the integrated filter assembly is arranged to filter an inlet of the vacuum source.
5. The end effector connector according to any one of clauses 1 to 4, wherein the end effector connector comprises a passage to fluidically connect the vacuum source and the suction device when the end effector is connected to the end effector connector in use.
6. The end effector connector according to clause 5, wherein the filter assembly is fluidically connected to the passage by an exhaust duct.
7. The end effector connector according to clause 5 or 6, wherein the filter assembly is arranged such that, when the end effector is connected to the end effector connector in use, the filter assembly is located between the suction device and the passage.
8. The end effector connector according to any one of clauses 1 to 7, wherein the end effector connector comprises the vacuum source as an integrated component.
9. The end effector connector according to clause 8, wherein the vacuum source comprises a venturi vacuum generator.
10. The end effector connector according to clause 9, wherein the integrated filter assembly is positioned downstream of the venturi vacuum generator.
11. The end effector connector according to clause 9 or 10, wherein the vacuum source comprises a vacuum manifold to fluidically connect the venturi vacuum generator to the suction device.
12. The end effector connector according to clause 11, wherein the vacuum manifold comprises a chamber and the venturi vacuum generator is housed within the chamber.
13. The end effector connector according to clause 12, wherein the integrated filter assembly is fluidically connected to the chamber to filter an exhaust of the venturi vacuum generator.
14. The end effector connector according to any one of clauses 1 to 13, further comprising a frame onto which the suction assembly is mounted.
15. The end effector connector according to clause 14, wherein the frame comprises one of a male or female end of a twist-lock connection system connected to the frame, wherein the one of the male or female end is configured to form a connection with the other of the male or female end of the twist-lock connection system, connected to the robotic arm, to secure the end effector to the robotic arm.
16. The end effector connector according to clause 15, wherein the twist-lock connection system comprises locking means to rotationally lock the male and female ends.
17. The end effector connector according to any one of clauses 14 to 16, further comprising a bearing assembly configured to movably mount the suction assembly to the frame.
18. The end effector connector according to clause 17, further comprising biasing means for biasing the suction assembly into a lowermost position with respect to the frame.
19. An end effector assembly comprising:
   the end effector connector according to any one of clauses 1 to 18; and
   an end effector comprising a suction device fluidically connected to the end effector connector.
20. A robotic manipulator comprising the end effector assembly according to clause 19.
21. A robotic picking station comprising the robotic manipulator according to clause 20.
22. A grid-based storage and retrieval system comprising the picking station according to clause 21.

1. An end effector connector arranged to connect:
a robotic arm; and
an end effector comprising a suction device to releasably engage an item, in use, with vacuum pressure generated by a vacuum source;
the end effector connector comprising an integrated filter assembly for the vacuum source.

2. The end effector connector according to claim 1, wherein the integrated filter assembly is arranged to filter an exhaust of the vacuum source.

3. The end effector connector according to claim 2, wherein the integrated filter assembly is a first integrated filter assembly, the end effector comprising a second integrated filter assembly arranged to filter an inlet of the vacuum source.

4. The end effector connector according to claim 1, wherein the integrated filter assembly is arranged to filter an inlet of the vacuum source.

5. The end effector connector according to claim 1, wherein the end effector connector comprises a passage to fluidically connect the vacuum source and the suction device when the end effector is connected to the end effector connector in use.

6. The end effector connector according to claim 5, wherein the filter assembly is fluidically connected to the passage by an exhaust duct.

7. The end effector connector according to claim 5, wherein the filter assembly is arranged such that, when the end effector is connected to the end effector connector in use, the filter assembly is located between the suction device and the passage.

8. The end effector connector according to claim 1, wherein the end effector connector comprises the vacuum source as an integrated component.

9. The end effector connector according to claim 8, wherein the vacuum source comprises a venturi vacuum generator.

10. The end effector connector according to claim 9, wherein the integrated filter assembly is positioned downstream of the venturi vacuum generator.

11. The end effector connector according to claim 9, wherein the vacuum source comprises a vacuum manifold to fluidically connect the venturi vacuum generator to the suction device.

12. The end effector connector according to claim 11, wherein the vacuum manifold comprises a chamber and the venturi vacuum generator is housed within the chamber.

13. The end effector connector according to claim 12, wherein the integrated filter assembly is fluidically connected to the chamber to filter an exhaust of the venturi vacuum generator.

14. The end effector connector according to claim 1, further comprising a frame onto which the suction assembly is mounted.

15. The end effector connector according to claim 14, wherein the frame comprises one of a male or female end of a twist-lock connection system connected to the frame, wherein the one of the male or female end is configured to form a connection with the other of the male or female end of the twist-lock connection system, connected to the robotic arm, to secure the end effector to the robotic arm.

16. The end effector connector according to claim 15, wherein the twist-lock connection system comprises locking means to rotationally lock the male and female ends.

17. The end effector connector according to claim 14, further comprising a bearing assembly configured to movably mount the suction assembly to the frame.

18. The end effector connector according to claim 17, further comprising biasing means for biasing the suction assembly into a lowermost position with respect to the frame.

19. An end effector assembly comprising:
the end effector connector according to claim 1; and
an end effector comprising a suction device fluidically connected to the end effector connector.

20. A robotic manipulator comprising the end effector assembly according to claim 19.

21. A robotic picking station comprising the robotic manipulator according to claim 20.

22. A grid-based storage and retrieval system comprising the picking station according to claim 21.
